(19) United States
(12) Patent Application Publication
(10) Pub. No.: US 2024/0271827 A1
(43) Pub. Date: Aug. 15, 2024

(54) SOLAR OPTICAL COLLECTOR SYSTEMS, METHODS OF MANUFACTURE, AND METHODS OF USE

(71) Applicant: Mun Chew Kong, Singapore (SG)

(72) Inventor: Stephen D. Newman, Singapore (SG)

(21) Appl. No.: 18/438,014

(22) Filed: Feb. 9, 2024

Related U.S. Application Data
(60) Provisional application No. 63/484,162, filed on Feb. 9, 2023.
(60) Provisional application No. 63/484,159, filed on Feb. 9, 2023.

(51) Int. Cl. F24S 23/30; F24S 60/30; G02B 1/00; G02B 27/10

(52) U.S. Cl. CPC F24S 23/30; F24S 60/30; G02B 1/002; G02B 27/1006

(57) ABSTRACT

An energy collection system including a light concentrating apparatus is disclosed. The light concentrating apparatus can include a light receiver and a light concentrator. The light concentrator can include a first concentrating lens with a first focal point on the light receiver and a second concentrating lens with a second focal point on the light receiver spaced apart from the first focal point. The second concentrating lens can be adjacent to the first concentrating lens in a direction parallel to a longitudinal axis of the light receiver.

### CROSS-REFERENCE TO RELATED APPLICATION

This patent application is a nonprovisional patent application of and claims priority to U.S. Provisional Application No. 63/484,162 titled “Solar Optical Collector Systems, Methods of Manufacture, and Methods of Use” and U.S. Provisional Application No. 63/484,159 and titled “Solar Optical Collector Systems, Methods of Manufacture, and Methods of Use,” the disclosure of each of which is hereby incorporated herein by reference in its entirety.

### BACKGROUND

Solar technologies can collect and convert solar radiation into electrical energy, which can be stored in a transfer medium. There are two major categories of solar technologies: photovoltaics (PVs) and concentrated solar power (CSP). PV technologies are inefficient, lost efficiency at high temperatures, and rely on heavy metal catalysts, which are rare, expensive, and environmentally damaging to obtain. CSP technologies are bulky; rely heavily on mirrors, which lose efficiency due to degradation and need to be cleaned; have large space and weight requirements; and need to track the sun in order to remain efficient, which costs energy, can be bulky and rely heavily on mirrors, which can lose reflective and refractive efficiency due to degradation and contaminant build-up on the mirrors. Conventional solar technologies can be unsuited to capture solar radiation as the sun moves in an arc throughout a day, without otherwise using power-intensive tracking devices. Further, the bulkiness and weight of such technologies can limit the installation and adaptability of the system.

### SUMMARY

Examples disclosed herein relate to solar energy collection, and more particularly to a light concentrating lens and energy collection system and methods to supply energy to an energy absorbing medium. In one aspect, a light concentrating lens includes a light-receiving surface and a light-exiting surface opposite the light-receiving surface. The light concentrating lens can be configured to direct light passing from the light-receiving surface to the light-exiting surface to a plurality of discrete focal points.

In some examples, the light concentrating lens can includes a plurality of lenslets. In some examples, each of the lenslets can direct light to a respective discrete focal point. In some examples, each of the lenslets can be biconic.

In some examples, at least one of the light-receiving surface or the light-exiting surface of a first lenslet of the lenslets can include a first radius of curvature and a second radius of curvature perpendicular to the first radius of curvature.

In some examples, the plurality of lenslets can include alternating concave and convex lenslets. In some examples, the plurality of lenslets can include a plurality of convex lenslets directly adjacent to one another.

In some examples, the light-receiving surface can be cylindrical and the light-exiting surface can be planar.

In one aspect, a concentrator apparatus includes a light receiver and a light concentrator. The light concentrator can include a first concentrating lens with a first focal point on the light receiver, and a second concentrating lens adjacent to the first concentrating lens in a direction parallel to a longitudinal axis of the light receiver. The second concentrating lens can have a second focal point on the light receiver. The second focal point can be spaced apart from the first focal point.

In some examples, the second concentrating lens can be directly adjacent the first concentrating lens. In some examples, the first concentrating lens and the second concentrating lens can be convex lenses.

In some examples, the concentrator apparatus can further include a third concentrating lens between the first concentrating lens and the second concentrating lens. In some examples, the first concentrating lens and the second concentrating lens can be convex lenses. In some examples, the third concentrating lens can be a concave lens. In some examples, the third concentrating lens can have a third focal point at least partially overlapping the first focal point and the second focal point.

In some examples, the light receiver can include a molecular solar thermal energy storage (MOST). In some examples, the light receiver and the light concentrator can include flexible materials.

In some examples, the concentrator apparatus can further include a transparent material encircling the light concentrator and the light receiver. In some examples, the transparent material can define at least a partial vacuum between the light concentrator and the light receiver.

In one aspect, a system includes a light receiver configured to conduct a heat transfer medium, and a light concentrator includes a cylindrical lens. The cylindrical lens can be configured to direct light passing through the light concentrator to a first focal point on the light receiver and a second focal point on the light receiver and spaced apart from the first focal point.

In some examples, the first focal point can be axially spaced apart from the second focal point. In some examples, the cylindrical lens can include a plurality of biconic lenslets.

In some examples, the system can further include a sterling engine coupled to an outlet of the light receiver. In some examples, the system can further include a water generator coupled to an outlet of the light receiver. In some examples, the water generator can be configured to generate water using heat from the heat transfer medium. In some examples, the system can further include an ammonia generator coupled to an outlet of the light receiver. In some examples, the ammonia generator can be configured to generate ammonia using heat from the heat transfer medium to capture water and perform electrolysis on the water.

In one aspect, a light concentrating lens includes a light-receiving surface and a light-exiting surface opposite the light-receiving surface. The light-receiving surface can include a plurality of nano-structures configured to resist build-up of contaminants. The light-concentrating lens can include an additive configured to shift a wavelength of light passing from the light-receiving surface to the light-exiting surface.

In some examples, the additive can include a phosphor. In some examples, the additive can include a quantum dot (QD). In some examples, the additive can include a luminophore. In some examples, the additive can further include a photosensitizer and a stabilizer. In some examples, the luminophore can include Eu3+; the photosensitizer can include hexafluoroacetylacetonato; and the stabilizer can include triphenylphosphine oxide.

In some examples, the nano-structures are spherical. In some examples, the nano-structures comprise prisms. In some examples, the nano-structures comprise lenticulars. In some examples, the nano-structures comprise linear Fresnel features.

In some examples, the additive can be configured to shift the wavelength of light passing from the light-receiving surface to the light-exiting surface from a shorter wavelength to a longer wavelength.

In one aspect, a structural beam includes a cable; a light receiver arranged around the cable; and a light concentrator arranged around the light receiver for omnidirectional concentration of light toward a first focal point on the light receiver and a second focal point on the light receiver spaced apart from the first focal point.

In some examples, the structural beam can further include a first end cap component attached to the light concentrator. The cable can extend through the first end cap component.

In some examples, the light concentrator can include a cylindrical lens. The cylindrical lens can be configured to direct light passing through the light concentrator to the first focal point and the second focal point on the light receiver.

In some examples, a system can include a building; a column; and a structural beam coupled to the building and the column. In some examples, a bridge can include an upper beam; a lower beam; and a structural beam coupled to the upper beam and the lower beam.

In one aspect, a system includes a light receiver configured to conduct a heat transfer medium; and a light concentrator comprising a cylindrical lens. The cylindrical lens can be configured to direct light passing through the light concentrator to a first focal point on the light receiver and a second focal point on the light receiver and spaced apart from the first focal point. The light concentrator can include laminated glass.

In some examples, the light concentrator can be configured to support a light in a lamppost.

In some examples, the system can further include a wind turbine. In some examples, the heat transfer medium can be configured to increase wind speed through the wind turbine. In some examples, the light concentrator can be an air foil of the wind turbine. In some examples, the light concentrator can be a structural support of the wind turbine.

In some examples, the wind turbine can include a first air intake; and a second air intake. In some examples, the first air intake can generate a low-pressure that can be configured to increase wind speed through the second air intake. In some examples, the heat transfer medium can be configured to increase wind speed through the second air intake.

In addition to the exemplary aspects and embodiments described above, further aspects and embodiments will become apparent by reference to the drawings and by study of the following description.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an isometric view of a system including a concentrator apparatus.

FIG. 2A shows a cross-sectional view of a concentrator apparatus.

FIG. 2B shows a cross-sectional view of a concentrating lens of the concentrator apparatus of FIG. 2A.

FIG. 3A shows a partial cut-away perspective view of a concentrator apparatus.

FIG. 3B shows a partial cut-away perspective view of a concentrator apparatus.

FIG. 4A shows an isometric view of a concentrating lens.

FIG. 4B shows an isometric view of a concentrating lens.

FIG. 5A shows a perspective view of a cylindrical lenslet.

FIG. 5B shows a perspective view of a biconic lenslet.

FIG. 6A shows a front view of a concentrating lens.

FIG. 6B shows a front view of a concentrating lens.

FIG. 7A shows a plan view of a concentrator apparatus.

FIG. 7B shows a plan view of a concentrator apparatus.

FIG. 7C shows a plan view of a concentrator apparatus.

FIG. 8 shows an isometric view of a heat transfer engine.

FIG. 9 shows a perspective view of a heat exchanger.

FIG. 10 shows a plan view of a system including a concentrator apparatus.

FIG. 11 shows a plan view of a system including a concentrator apparatus and an energy conversion apparatus.

FIG. 12A shows partial cut-away perspective view of an optical material.

FIG. 12B shows partial cut-away perspective view of an optical material.

FIG. 12C shows partial cut-away perspective view of an optical material.

FIG. 12D shows partial cut-away perspective view of an optical material.

FIG. 13 shows a perspective view of a building including concentrator apparatuses.

FIG. 14 shows a perspective view of a support including a concentrator apparatus.

FIG. 15 shows a perspective view of a bridge including concentrator apparatuses.

FIG. 16 shows a perspective view of a lamppost including a concentrator apparatus.

FIG. 17 shows a perspective view of a wind turbine including concentrator apparatuses.

### DETAILED DESCRIPTION

The description that follows includes sample systems, methods, and apparatuses that embody various elements of the present disclosure. However, it should be understood that the described disclosure can be practiced in a variety of forms in addition to those described herein.

The following disclosure describes systems and techniques to facilitate the collection and concentration of solar radiation into a heat transfer medium. A solar optical collection system including a concentrator apparatus can be provided to collect solar radiation and transfer thermal energy to a heat transfer medium. Sample heat transfer mediums can include water, a glycol/water mixture, hydrocarbon oils, refrigerants/phase change fluids, silicones, molten salts, a molecular solar thermal energy storage, or a zeolite-based thermal storage. The concentrator apparatus can include an arrangement of concentrating optical lenses that are arranged about the heat transfer medium. The concentrating lenses can be adapted to collect solar radiation and direct and focus the solar radiation toward the heat transfer medium. The heat transfer medium receives the focused solar radiation and stores the solar radiation as heat energy. Conventional solar thermal systems are often limited by the position of the sun (e.g., as the sun moves in an arc throughout a day (e.g., the solar zenith angle) and as the position of the sun changes through seasons throughout a year (e.g., the solar azimuth angle)) or otherwise include bulky, power-intensive tracking systems that are used to physically manipulate and move the entire conventional system.

The concentrator apparatuses of the present disclosure can mitigate such hindrances by providing a system that can collect solar radiation agnostic to a position of the sun. For example, concentrator apparatus can be adapted to collect solar radiation as the sun progresses along a day arc or other path through the sky. Further, concentrator apparatus can be adapted to collect solar radiation as the position of the sun changes throughout seasons of the year or as other path or positional changes of the sun occur. The solar radiation can be collected without moving the lenses or other structures that collect the solar radiation.

To facilitate the foregoing, the concentrator apparatus can include an arrangement of concentrating lenses that are positioned about the heat transfer medium. In some cases, the arrangement of concentrating lenses can be positioned circumferentially spaced about the heat transfer medium. The arrangement can allow a first subset of concentrating lenses to collect solar radiation when the sun is in a first position. The arrangement can further allow a second subset of concentrating lenses to collect solar radiation as the sun progresses along the day arc and into a second position. The arrangement of lenses can thus be configured for the omnidirectional concentration of light toward the heat transfer medium. The arrangement can include a plurality of rod lenses, with variation along the lengths of the rod lenses (e.g., the rod lenses can include a plurality of biconic lenslets arranged along the lengths of the rod lenses). This configuration of the rod lenses can allow the rod lenses to collect solar radiation when the sun moves through seasonal position changes, such as when longitudinal axes of the rod lenses are disposed at angles oblique to incident light from the sun. The concentrating apparatus can therefore effectively track the sun without moving the components of the apparatus that collect and concentrate the solar radiation. The bulk and power-consumption of the concentrating apparatus can therefore be reduced.

The lightweight design of the concentrator apparatus can be facilitated in part by the use of optical lenses to concentrate and collect the solar radiation. Optical lenses can weigh less than bulky mirrors used in conventional solar thermal systems. Optical lenses can also deliver more concentration of solar radiation to a heat transfer medium for a given footprint than mirrors. This can allow the overall size of the concentrator apparatus to be reduced. In turn, the concentrator apparatuses of the present disclosure can be adapted for installation in a wider variety of locations, including installing the concentrator apparatuses on the roof of a building or other preexisting structure, which can facilitate implementation with existing infrastructure. The concentrator apparatuses can also be adapted for installation with a variety of other applications, including installation with a wind turbine, trees, a truck, and/or a shipping container. Further, the concentrator apparatuses can be used to generate energy, and/or can adapted to be paired with a variety of other technologies, such as Sterling engines, steam turbines, molecular solar thermal energy storage (MOST), perovskites, ammonia generation, fuel generation, water generation, heating and cooling devices, and the like.

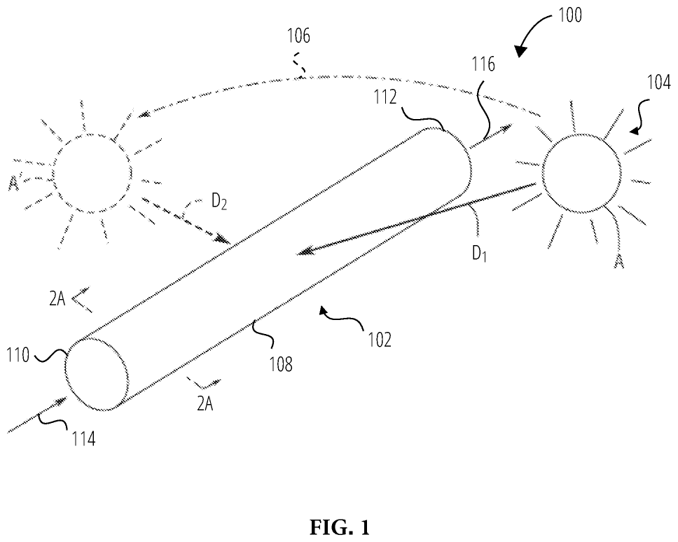

These and other examples are discussed below with reference to FIGS. 1 through 17. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

The concentrator apparatuses of the present disclosure can mitigate such hindrances by providing a system that can collect solar radiation agnostic to a position of the sun. For example, concentrator apparatus can be adapted to collect solar radiation as the sun progresses along various paths through the sky, such as along a day arc and through seasonal position changes. The concentrator apparatus can be configured to collect solar radiation without moving the lenses or other structures that collect the solar radiation.

To facilitate the foregoing, the concentrator apparatus can include one or more concentrating lenses that are positioned around a heat transfer medium. In some examples, the concentrating lenses can be positioned to circumferentially surround the heat transfer medium. In some examples, a first subset of the concentrating lenses can be configured to collect solar radiation when the sun is in a first position. A second subset of concentrating lenses can be configured to collect solar radiation as the sun progresses along the day arc and into a second position. Thus, the concentrating lenses can be configured for omnidirectional concentration of solar radiation toward the heat transfer medium. The concentrating lenses can include one or more rod lenses, which can have shapes that vary along the lengths of the rod lenses (e.g., the rod lenses can include a plurality of biconic lenslets arranged along the lengths of the rod lenses). This configuration of the rod lenses can allow the rod lenses to collect solar radiation as the sun moves through seasonal position changes, such as when longitudinal axes of the rod lenses are disposed at angles oblique to incident light from the sun. The concentrating apparatus can therefore effectively track the sun without moving the components of the apparatus that collect and concentrate the solar radiation. The bulk and power-consumption of the concentrating apparatus can therefore be reduced.

The lightweight design of the concentrator apparatus can be facilitated in part by the use of optical lenses to concentrate and collect solar radiation. The optical lenses can weigh less than bulky mirrors used in conventional solar thermal systems. The optical lenses can deliver a greater concentration of solar radiation to the heat transfer medium for a given footprint than mirrors. This allows the overall size of the concentrator apparatus to be reduced. In turn, the concentrator apparatuses of the present disclosure can be adapted for installation in a wider variety of locations, including installing the concentrator apparatuses on roofs of buildings or other structures, utilizing the concentrator apparatuses in other structures, such as wind turbines, and the like. In some examples, components of the concentrator apparatuses can be formed of structural glass or the like, and the concentrator apparatuses can be used as structural members (e.g., beams) or the like. In some examples, the concentrator apparatuses can be formed of glasses that include phosphors, quantum dots (QDs), or the like, which alter the wavelength of incident light to longer wavelengths, and increase heat generated by the concentrator apparatuses. The concentrator apparatuses can be used to generate energy, and/or can adapted to be paired with a variety of other technologies, such as wind turbines, Sterling engines, steam turbines, molecular solar thermal energy storage (MOST), perovskites, ammonia generation, fuel generation, water generation, heating and cooling devices, and the like.

These and other examples are discussed below with reference to FIGS. 1 through 17. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a light concentrator apparatus 102 of a solar optical collection system 100. The concentrator apparatus 102 can be adapted to receive solar radiation from a plurality of different incident angles and concentrate the solar radiation towards a heat transfer medium. The heat transfer medium can be used to absorb energy in any form, and may be referred to as an energy absorbing medium. A plurality of the concentrating optical lenses can define an arrangement within the concentrator apparatus 102 that allows at least a subset of the concentrating optical lenses to receive and focus the solar radiation. This allows the solar optical collection system 100 to receive solar energy as the sun 104 moves along a day arc 106.

By way of schematic illustration, FIG. 1 shows the sun 104 relative to the concentrator apparatus 102. The sun 104 can move generally along the day arc 106 between a first position A and a second position A′. The sun 104 can emit solar radiation in a direction D₁ when the sun 104 is in the first position A. The sun 104 can emit solar radiation in a direction D₂ when the sun 104 is in the second position A′. The concentrator apparatus 102 can be adapted to receive solar radiation from the sun 104 in the first direction D₁, the second direction D₂, and directions there between, and direct and concentrate the solar radiation toward the heat transfer medium held within the concentrator apparatus 102. The solar radiation can be received without moving or manipulating the concentrating optical lenses and other optical components of the concentrator apparatus 102.

The concentrator apparatus 102 is illustrated in FIG. 1 as having a cylindrical body 108. The cylindrical body 108 can define a pipe, tube, conduit, or other structure that allows the concentrator apparatus 102 to direct a heat transfer medium between an input end 110 and an output end 112 of the concentrator apparatus 102. The concentrator apparatus 102 can receive an input flow 114 at the input end 110 and can emit an output flow 116 at the output end 112.

The heat transfer medium can be introduced into the concentrator apparatus 102 at the input end 110 via the input flow 114. The concentrator apparatus 102 can direct and concentrate solar radiation towards the heat transfer medium as the heat transfer medium moves through the concentrator apparatus 102, such that the heat transfer medium receives thermal energy from the sun 104 via the concentrator apparatus 102. The heat transfer medium can receive thermal energy in concentrated form from the sun 104 notwithstanding a position of the sun 104 along the day arc 106. For example, the heat transfer medium can receive thermal energy from the sun 104 when the sun 104 is in the first position A and when the sun 104 is in the second position A′. In some examples, the heat transfer medium can receive thermal energy from the sun 104 at any position of the sun 104 along the day arc 106. The concentrator apparatus 102 can therefore be configured to receive thermal energy transfer throughout the day, and without moving or otherwise manipulating the concentrating optical lenses or other optical components of the concentrator apparatus 102.

The heat transfer medium can receive thermal energy from the sun 104 as the azimuth of the sun 104 changes throughout the year (e.g., as seasons change). In some examples, the heat transfer medium can receive thermal energy from the sun 104 at any position of the sun 104 throughout the year, such as when a longitudinal axis of the concentrator apparatus 102 is at an angle oblique to an incident angle of light from the sun 104. The concentrator apparatus 102 can therefore be configured to receive thermal energy transfer throughout the year, and without moving or otherwise manipulating the concentrating optical lenses or other optical components of the concentrator apparatus 102.

In some examples, the heat transfer medium can include a fluid, such as a gas or a liquid. The heat transfer medium can include water, hydrocarbon oils, molten salts, glycols (e.g., ethylene glycol, propylene glycol, or the like), refrigerants, phase change fluids, ionic liquids, zeolite materials, silicones, combinations thereof, or the like. In examples in which the heat transfer medium includes zeolite materials, the heat transfer medium can include zeolite pellets. The zeolite materials can release water when heated, and release heat when they come into contact with water. In examples in which the heat transfer medium includes ionic liquids, the ionic liquids can be salts of ions that are liquids at very low temperatures, and have low viscosity and corrosivity. The ionic liquids can include organic cations and organic or inorganic anions. Any suitable heat transfer mediums can be used.

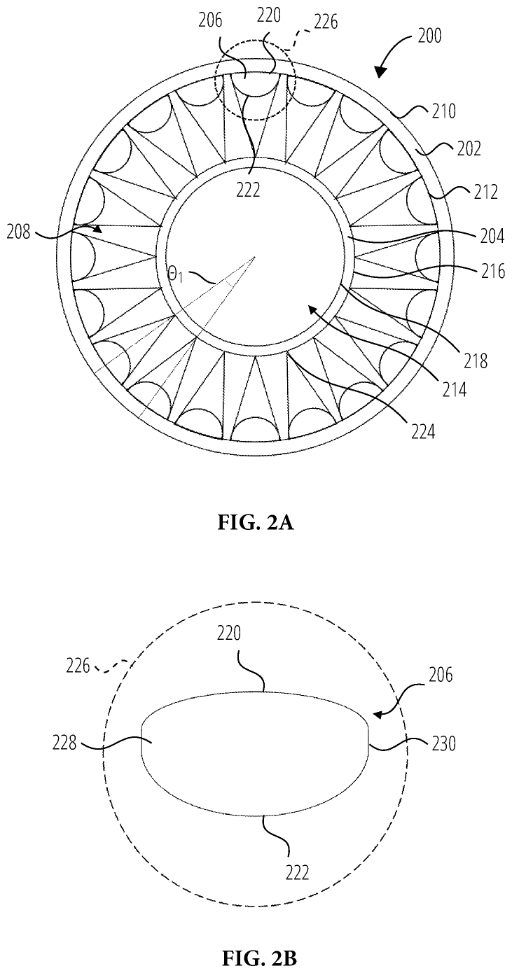

FIG. 2A illustrates a cross-sectional view of a concentrator apparatus 200. The concentrator apparatus 200 of FIG. 2A can be similar to or the same as the concentrator apparatus 102 of FIG. 1. FIG. 2A illustrates the concentrator apparatus 200 along the plane 2A-2A of the concentrator apparatus 102 illustrated in FIG. 1. The concentrator apparatus 200 includes an outer member 202, an inner member 204, and an arrangement of concentrating lenses 206 disposed in an annular region 208 between the outer member 202 and the inner member 204.

The outer member 202 can be a first portion of the concentrator apparatus 200 that is adapted to receive radiation energy, such as radiation energy emitted from the sun (e.g., solar radiation energy), there through. The outer member 202 includes an outer member first surface 210 and an outer member second surface 212. The outer member 202 can be a transparent or partially transparent structure that receives light though a thickness of the outer member 202 defined between the outer member first surface 210 and the outer member second surface 212. The outer member 202 can be a cylindrical component or an annular cylindrical component and can define a tube or pipe that extends along an axis of the concentrator apparatus 200. In some examples, the outer member 202 can be asymmetrical, which can increase radiation energy received through the outer member 202, decrease costs of the outer member 202, decrease the size and weight of the outer member 202, or combinations thereof.

The inner member 204 can be a second portion of the concentrator apparatus 200 that is adapted to encircle and transport a heat transfer medium. The inner member 204 can be a radiation energy receiver that receives the radiation energy emitted from the outer member 202 and the concentrating lenses 206. The inner member 204 can be an annular cylindrical component, and can define or be associated with a pipe or tube that defines an internal volume 214. The heat transfer medium can flow through the internal volume 214 of the inner member 204. The inner member 204 includes an inner member first surface 216 and an inner member second surface 218. The inner member first surface 216 and the inner member second surface 218 can define opposing surfaces of a pipe, for example, with the internal volume 214 defined therein. Although the inner member 204 is illustrated as being annular; in some examples, the inner member 204 can be asymmetrical. In some examples, providing an asymmetrical inner member 204 can increase radiation energy received by the inner member 204, decrease costs of the inner member 204, decrease the size and weight of the inner member 204, or combinations thereof.

In some examples, the inner member 204 can be at least partially formed from a copper tubing. Copper tubing can reduce the overall cost of the concentrator apparatus 200, while providing heat-absorbing characteristics adapted to transfer energy to the heat transfer medium disposed in the internal volume 214. As an example, the copper tubing can have a thermal conductivity of around 386.0 W/m*C. A coating, such as a paint designed for high temperatures, can be applied to the copper tubing. The inner member 204 can be heat-resistant, such as being heat-resistant to temperatures as high as 500 degrees Fahrenheit, or higher. In some examples, a coating can be applied to the outer member 202 in addition to or instead of the inner member 204.

In some examples, perovskite materials can be used for the inner member 204. For example, the inner member 204 can include flexible perovskite solar cells or the like, which can directly generate electrical energy from the radiation energy supplied through the outer member 202 and the concentrating lenses 206. Perovskite materials can have advantages of high flexibility, lightweight, portable, semitransparent, and can be compatible with a range of electronic products. In some examples, the perovskite materials can be included in the inner member 204 in addition to the heat transfer medium contained within the internal volume 214, which can increase power generation from the concentrator apparatus 200. The perovskite materials can be applied to the inner member 204 through spray-cast techniques or the like. By incorporating perovskite materials in the concentrator apparatus 200, the concentrator apparatus 200 can capture both thermal energy and electrical energy for added efficiency and energy generation.

In some examples, the inner member 204 can include a molecular solar thermal energy storage system (MOST). The MOST can include photoswitches, formed of a norbornadiene derivative, that include a catalyst cobalt phthalocyanine on a carbon support. The MOST can absorb sunlight to undergo a chemical isomerization to a metastable high energy species in order to store solar energy.

In the example of FIG. 2A, the outer member 202 and the inner member 204 are shown as concentric components. However, in some examples, the outer member 202 and the inner member 204 can be eccentric, and can be asymmetrical, which can be used to increase light collection by the inner member 204. The annular region 208 can be defined between the outer member 202 and the inner member 204. In some examples, the annular region 208 can be under a vacuum or a partial vacuum. While the annular region 208 is illustrated in FIG. 2A as being symmetric about a longitudinal axis of the concentrator apparatus 200, other shapes and arrangements are contemplated herein. For example, one or both of the inner member 204 and the outer member 202 can be shaped into a coil, such as a tight coil. The coil can wrap around and extend into a center of the coil in order to mitigate thermal energy escaping. The coil can be a 3D printed coil using printable stainless steel, as one example. An example material include the Corrax® product distributed by Uddeholm USA of Elgin, Illinois. In this regard, the annular region 208 can be any appropriate shaped defined between the outer member 202 and the inner member 204. In some examples, the inner member 204 and the outer member 202 can be D-shaped, elliptical, ovate, lanceolate, or the like, and the annular region 208 can have a corresponding shape.

The inner member 204 and the outer member 202 can be adapted to hold the concentrating lenses 206 therebetween. For example, the inner member 204 and the outer member 202 can be adapted to hold the concentrating lenses 206 within the annular region 208. With reference to FIG. 2A, an illustrative concentrating lens 206 is shown having a lens first surface 220 and a lens second surface 222. The lens first surface 220 can be associated with the outer member 202. For example, the lens first surface 220 can be arranged adjacent to or otherwise facing the outer member 202. The lens second surface 222 can be associated with the inner member 204. For example, the lens second surface 222 can be arranged adjacent to or otherwise facing the inner member 204. In the example of FIG. 2A, the lens first surface 220 is attached to and in contact with the outer member second surface 212 of the outer member 202 and spaced apart from the inner member first surface 216 of the inner member 204; however, each of the concentrating lenses 206 can be attached to and/or separated from the outer member second surface 212 of the outer member 202 and/or the inner member first surface 216 of the inner member 204. In some examples, a radius of the outer member 202 and/or a radius of the concentrating lenses 206 can be double a radius of the inner member 204. In some examples, the radius of the inner member 204 can be double a radius of each of the concentrating lenses 206.

Each of the concentrating lenses 206 can be configured to receive solar radiation through the outer member 202 at the lens first surface 220. The concentrating lenses 206 can be refractive lenses. A respective concentrating lens 206 can be configured to receive solar radiation and direct the solar radiation to the lens second surface 222 where the solar radiation is emitted toward the inner member 204. The solar radiation can be concentrated via its propagation through the concentrating lens 206. In some examples, the lens second surface 222 can define a plurality of refractive surfaces that direct the solar radiation toward a common focal point 224 when the radiation is emitted from the concentrating lens 206. In some examples, the lens second surface 222 can include one or more smoothly or otherwise continuous and contoured surfaces that transition light toward the focal point 224 for concentration on the inner member 204.

As illustrated in FIG. 2A, the solar radiation can be propagated from the lens second surface 222 towards the focal point 224. The focal point 224 can be defined on the inner member 204. In some examples, the focal point 224 can be defined within a body of the inner member 204, including being within the internal volume 214. The focal point 224 can be tuned based on an effective focal length of the concentrating lens 206. Focal lengths in a range from about 15 mm to about 25 mm or the like can be used.

The arrangement of the concentrating lenses 206 can include any appropriate number of the concentrating lenses 206 in order to facilitate the omnidirectional concentration of light on the inner member 204 or another light receiver. For example, the concentrating lenses 206 can be positioned about the inner member 204, such as about a circumference of the inner member 204. As illustrated in FIG. 2A, the concentrating lenses 206 can encircle the inner member 204. In some examples, the concentrating lenses 206 can be evenly circumferentially spaced (e.g., radially spaced) about the inner member 204. This arrangement can allow a subset of the concentrating lenses 206 to receive solar radiation from the sun as the sun travels through a day arc, as at least one or more of the concentrating lenses 206 directly faces the sun for a given position of the sun along the day arc. Any appropriate number of the concentrating lenses 206 can be integrated with the concentrator apparatus 200 in order to capture solar radiation from a variety of different azimuths and altitudes of the sun. In the example of FIG. 2A, 20 of the concentrating lenses 206 are provided. However, in some examples, more or fewer of the concentrating lenses 206 can be provided, such as providing at least 30 lenses, at least 50 lenses, at least 70 lenses, at least 100 lenses, or more about the inner member 204.

Each of the concentrating lenses 206 can be adapted to concentrate light towards a respective focal point 224 on or adjacent to the inner member 204. Each of the focal points 224 can each be a different point on the inner member 204 or another light receiver. For example, each of the focal points 224 can be circumferentially spaced about the inner member 204 generally corresponding to the circumferential spacing of the concentrating lenses 206. In some examples, one or more of the concentrating lenses 206 can be arranged such that one or more or all of the focal points 224 of the concentrating lenses 206 overlap with one another.

In some examples, the outer member 202 and/or the concentrating lenses 206 can be formed of homeopathic materials. Specifically, the outer member 202 and/or the concentrating lenses 206 can be formed of self-healing materials, which decreases maintenance costs of the concentrator apparatus 200.

The outer member 202 and/or the concentrating lenses 206 can be formed of hydrophobic materials, can include a hydrophobic coating, or the like. In some examples, the outer member 202 and/or the concentrating lenses 206 can be formed of oleophobic materials, can include an oleophobic coating, or the like. Performing nano-shaping on the surfaces of the outer member 202 can produce an extremely smooth exterior surface of the outer member 202. In some example, nano-structures can be formed on surfaces of the outer member 202 through a process such as nano-shaping. In some examples, nano-spheres, micro-spheres, or other features can be formed in external surfaces of the outer member 202 to repel contaminants from the external surfaces of the outer member 202. Providing hydrophobic materials, oleophobic materials, and/or nano-shaping for the outer member 202 can result in exterior surfaces of the concentrator apparatus 200 being self-cleaning by repelling dust, dirt, debris, water, and other contaminants. This improves the efficiency of the concentrator apparatus 200 over time, as contaminants are prevented from building up on surfaces of the concentrator apparatus 200, which could block light from passing into the concentrator apparatus 200. Further, maintenance costs for cleaning the concentrator apparatus 200 are decreased.

The outer member 202, the concentrating lenses 206, and/or the inner member 204 can be formed of materials that alter wavelengths of incident light. In some examples, materials of the outer member 202, the concentrating lenses 206, and/or the inner member 204 can include phosphors, quantum dots (QDs), or the like that shift the wavelengths of incident light to longer wavelengths. For example, the phosphors, quantum dots (QDs), or the like can shift wavelengths of incident light from ultraviolet (UV) wavelengths to red wavelengths or the like. This can increase the transfer of incident radiation energy to heat energy, which can be captured by the heat transfer medium in the internal volume 214. This can increase the efficiency of the concentrator apparatus 200.

The outer member 202 and/or the concentrating lenses 206 can be formed of materials that block certain wavelengths, such as harmful wavelengths, and can be used to supply light to gardens or the like, without supplying harmful wavelengths. This may allow for year-round growing, maximize light, and increase photosynthesis. In some examples, the outer member 202 and/or the concentrating lenses 206 can be formed of flexible materials, such that the concentrator apparatus 200 can be wrapped around structures, such as trees or the like. This allows the concentrator apparatus 200 to be installed on a range of surfaces for a variety of applications.

FIG. 2B illustrates a detail view of a concentrating lens 206 in region 226 of FIG. 2A. The concentrating lens 206 includes a lens body 228. The lens body 228 can define a cylindrical rod lens. The rod lens includes a first surface contour defined on the lens first surface 220. The rod lens includes a second surface contour defined on the lens second surface 222. The first and second surface contours can be optimized for solar radiation concentration by modeling the rod lens as biconic or a similar type surface. Compared to a rotationally symmetric conic surface, the biconic surface has additional degrees of freedom with different curvature and conic parameters in the x and y direction.

As illustrated in FIG. 2B, the concentrating lens 206 can be biconvex; however, in some examples, the concentrating lens 206 can be plano-convex, positive meniscus, negative meniscus, or the like. Although the lens first surface 220 and the lens second surface 222 are illustrated as having smooth curved surfaces, at least a portion of the lens first surface 220 and/or the lens second surface 222 can be flat or the like. The first and second surface contours can thus be tuned in a manner analogous to the correction of primary aberrations, such as spherical aberration, coma and primary astigmatism, as well as secondary astigmatism. In some cases, a half Maddox optics structure can be utilized. Additionally or alternately, one or both of the first and second surface contours can include a plurality of refractive surfaces.

The rod lens includes planar lens side surfaces 230 extending between the lens first surface 220 and the lens second surface 222. In some examples, the lens side surfaces 230 can be tapered, curved, or the like. In some examples, the lens side surfaces 230 can interface with lens side surfaces 230 of adjacent concentrating lenses 206, and adjacent concentrating lenses 206 can have corresponding lens side surfaces 230. In some examples, the concentrating lens 206 can include a central thickness between the lens first surface 220 and the lens second surface 222 in a range from about 5 mm to about 40 mm.

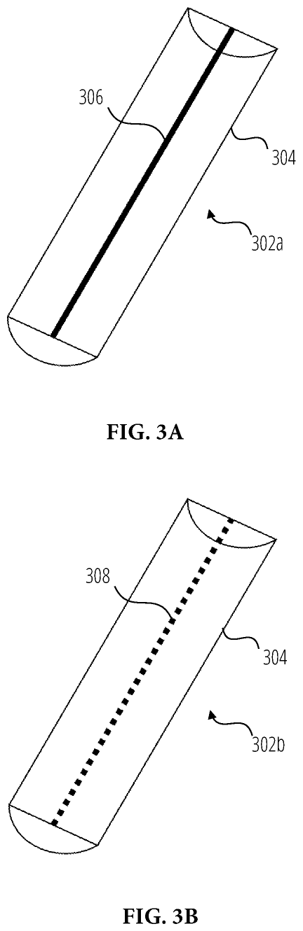

FIGS. 3A and 3B illustrate partial cut-away views of different focal configurations for concentrating lenses of concentrator apparatuses. In FIG. 3A, a concentrator apparatus 302a includes concentrating lenses that are rod lenses arranged around a circumference of an outer member 304. The concentrating lenses can be cylindrical, or have shapes that do not vary along a length of the concentrating lenses, which produces line focal axes 306. The focal axis 306 of each respective concentrating lens can be on or within an inner member of the concentrator apparatus 302a.

In FIG. 3B, a concentrator apparatus 302b includes concentrating lenses that are rod lenses, which each include a plurality of biconic lenslets. The biconic lenslets produce discrete point foci, with each biconic lenslet producing a focal point 308. The discrete point foci may each be separated from adjacent point foci by a distance. The biconic lenslets can be arranged adjacent to one another along a longitudinal axis of respective concentrating lenses. Each concentrating lens can produce a plurality of focal points 308 along a longitudinal axis parallel to a longitudinal axis of the concentrating lens. The concentrating lenses can be arranged around a circumference of an outer member 304.

Including the concentrating lenses that each include a plurality of biconic lenslets in the concentrator apparatus 302b of FIG. 3B changes the focal configuration of the concentrator apparatus 302b from a line focus (i.e., the focal axes 306 of the concentrator apparatus 302a of FIG. 3A), to discrete point foci. This improves the maximum solar concentration ratio of the concentrator apparatus 302b, such as by about 17 times. Moreover, including the plurality of biconic lenslets helps to increase the radiation energy captured by the concentrator apparatus 302b, even when there are seasonal solar angle changes (e.g., the solar angle is oblique to a longitudinal axis of the concentrator apparatus 302b). This improves performance of the concentrator apparatus 302b throughout the year, without requiring that the position or angle of the concentrator apparatus 302b be adjusted throughout the year. The improved focusing and capture of radiation energy by the concentrator apparatus 302b results in a heat transfer medium heated by the concentrator apparatus 302b being heated to a greater temperature such that the concentrator apparatus 302b produces more thermal energy.

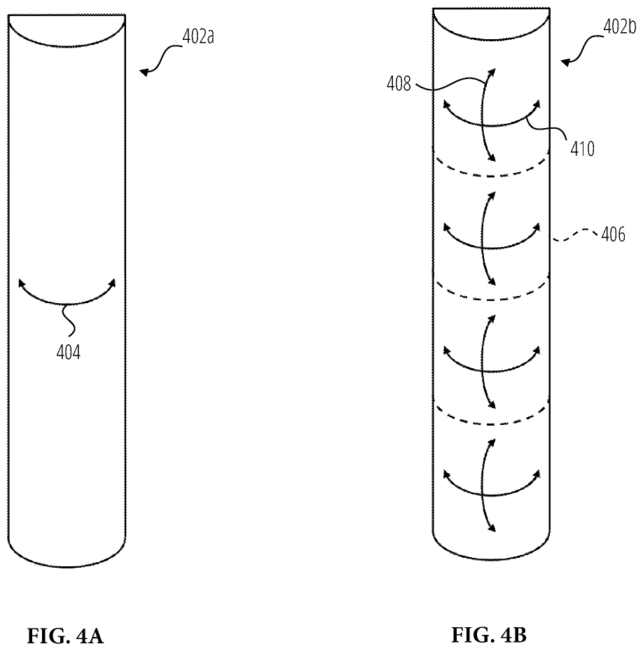

FIGS. 4A and 4B illustrate perspective views of concentrating lenses that can be used in concentrating apparatuses, such as the concentrating apparatuses discussed above with respect to FIGS. 1 through 3B. FIG. 4A illustrates a concentrating lens 402a that is a rod lens and has a same radius of curvature 404 extending the length of the concentrating lens 402a. Although the concentrating lens 402a is illustrated as having a D-shaped cross section, the concentrating lens 402a can have a biconvex, plano-convex, positive meniscus, negative meniscus, elliptical, ovate, lanceolate, or the like cross-sectional shape. Providing the concentrating lens 402a with a shape that does not vary along a length of the concentrating lens 402a can produce a line focal axis, such as the example of FIG. 3A.

FIG. 4B illustrates a concentrating lens 402b that is a rod lens, which includes a plurality of biconic lenslets 406. Each biconic lenslet 406 can include a first radius of curvature 408 around an axis parallel to a longitudinal axis of the concentrating lens 402b and a second radius of curvature 410 around an axis perpendicular to the longitudinal axis of the concentrating lens 402b. The first radius of curvature 408 and the second radius of curvature 410 of adjacent biconic lenslets 406 can be the same or different. In some examples, adjacent biconic lenslets 406 can have opposite curves, such as a first biconic lenslet having concave surfaces and an adjacent second biconic lenslet having convex surfaces. Although the biconic lenslets 406 are illustrated as having D-shaped cross sections, the biconic lenslets 406 can have biconvex, plano-convex, positive meniscus, negative meniscus, elliptical, ovate, lanceolate, or the like cross-sectional shapes, in a direction parallel to the first radius of curvature 408 and/or a direction parallel to the second radius of curvature 410. Each of the biconic lenslets 406 can focus incident light to a point and produce a focal point, such as the example of FIG. 3B.

Including the plurality of biconic lenslets 406 in the concentrating lens 402b causes the concentrating lens 402b to produce a plurality of point foci parallel to a longitudinal axis of the concentrating lens 402b. Each point focus may be separated by adjacent point foci by a distance. As compared to the concentrating lens 402a of FIG. 4A, which produces a line focal axis, the concentrating lens 402b has an improved maximum solar concentration ratio, provides improved focusing when an angle of incident light is oblique to a longitudinal axis of the concentrating lens 402b (e.g., due to seasonal changes in the position of the sun), and heats a heat transfer medium to a greater temperature. Thus, the concentrating lens 402b that includes the plurality of biconic lenslets 406 can be used to produce a greater amount of thermal energy.

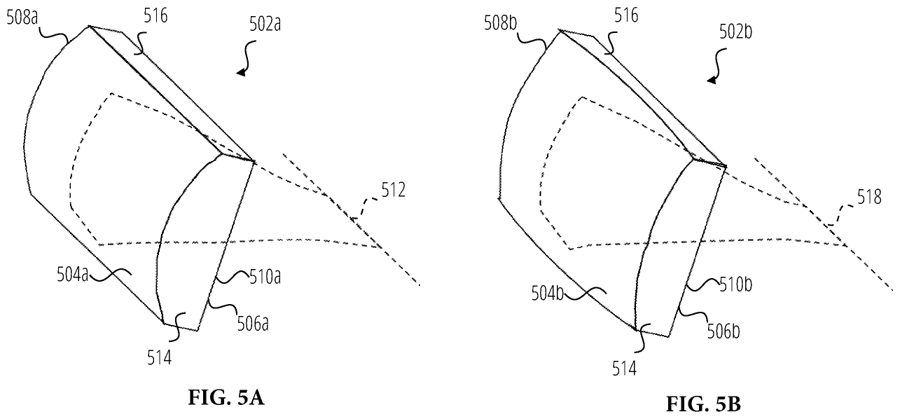

FIGS. 5A and 5B illustrate perspective views of a cylindrical lenslet 502a and a biconic lenslet 502b, respectively. In FIG. 5A, the cylindrical lenslet 502a includes a lens first surface 504a and a lens second surface 506a opposite the lens first surface 504a. A first surface contour of the lens first surface 504a can be defined by a cylindrical portion 508a. A second surface contour of the lens second surface 506a can be defined by a projection portion 510a opposite the cylindrical portion 508a. The projection portion 510a can be planar. In some examples, the lens first surface 504a and the lens second surface 506a can be cylindrical, spherical, planar, aspherical, combinations thereof, or the like. In some examples, the lens first surface 504a and the lens second surface 506a can be tuned to emit radiation toward a line focal axis 512. For example, the lens first surface 504a and the lens second surface 506a can define one or more refractive surfaces that direct light for convergence on the focal axis 512.

FIG. 5A further shows the cylindrical lenslet 502a having an axial face 514. Multiple cylindrical lenslets 502a can be arranged with one another along an axis of a concentrator apparatus, such as to form concentrating lenses that are rod lenses. In some examples, the cylindrical lenslets 502a can be connected end-to-end, with an axial face 514 of a cylindrical lenslet 502a being engaged with an axial face 514 of an adjacent cylindrical lenslet 502a. This can be beneficial for defining an axial length of a concentrating lens, as well as an axial length of a line focal axis. A desired number of cylindrical lenslets 502a can be arranged such that the line focal axis of a concentrating lens extends along an entire length of an inner member, a pipe, or another light receiver that contains a heat transfer medium. Each cylindrical lenslet 502a can also include a circumferential face 516. As described herein, the cylindrical lenslets 502a, which can form the concentrating lenses, can be arranged circumferentially about the light receiver. In this regard, the cylindrical lenslets 502a can be connected with one another side-by-side, with a circumferential face 516 of a cylindrical lenslet 502a being engaged with a circumferential face 516 of an adjacent cylindrical lenslet 502a.

In FIG. 5B, the biconic lenslet 502b includes a lens first surface 504b and a lens second surface 506b opposite the lens first surface 504b. A first surface contour of the lens first surface 504b can be defined by a spherical portion 508b. A second surface contour of the lens second surface 506b can be defined by a projection portion 510b opposite the spherical portion 508b. The projection portion 510b can be planar. In some examples, the lens first surface 504b and the lens second surface 506b can be cylindrical, spherical, planar, aspherical, combinations thereof, or the like. Although the lens first surface 504b is illustrated as having convex surfaces, in some example, various surfaces of the lens first surface 504b and/or the lens second surface 506b can be concave. In some examples, the lens first surface 504b and the lens second surface 506b can be tuned to emit radiation toward a focal point 518. For example, the lens first surface 504b and the lens second surface 506b can define one or more refractive surfaces that direct light for convergence on the focal point 518. In some examples, such as examples in which the lens first surface 504b and/or the lens second surface 506b include concave surfaces, the lens first surface 504b and the lens second surface 506b can be tuned to emit radiation toward two distinct focal points.

FIG. 5B further shows the biconic lenslet 502b having an axial face 514. Multiple biconic lenslets 502b can be arranged with one another along an axis of a concentrator apparatus, such as to form concentrating lenses that are rod lenses. In some examples, the biconic lenslets 502b can be connected end-to-end, with an axial face 514 of a biconic lenslet 502b being engaged with an axial face 514 of an adjacent biconic lenslet 502b. This can be beneficial for defining an axial length of a concentrating lens, as well as a number of the focal points 518. A desired number of biconic lenslets 502b can be arranged such that the focal points 518 of a concentrating lens extend along an entire length of an inner member, a pipe, or another light receiver that contains a heat transfer medium. Each biconic lenslet 502b can also include a circumferential face 516. As described herein, the biconic lenslets 502b, which can form the concentrating lenses, can be arranged circumferentially about the light receiver. In this regard, the biconic lenslets 502b can be connected with one another side-by-side, with a circumferential face 516 of a biconic lenslet 502b being engaged with a circumferential face 516 of an adjacent biconic lenslet 502b.

The biconic lenslets 502b can be arranged axially adjacent one another and circumferentially adjacent one another around a light receiver to define a plurality of focal points 518 in both the axial direction and the circumferential direction on the light receiver. The cylindrical lenslets 502a can be arranged axially adjacent one another and circumferentially adjacent one another around a light receiver to define a plurality of line focal axes 512 in the circumferential direction on the light receiver. Providing the biconic lenslets 502b can improve focusing of concentrating lenses in cases in which light from a light source (e.g., the sun) is incident to the biconic lenslets 502b at an angle oblique to a longitudinal axis of the concentrating lenses. This may be caused, for example, by changes in the solar angle through changing seasons and the like. Thus providing the biconic lenslets 502b can improve the efficiency of energy collection, even through seasonal changes, and can eliminate the need for additional equipment to re-orient a concentrator apparatus periodically throughout the year. Further, providing the biconic lenslets 502b can increase the maximum solar energy concentration ratio provided by the concentrating lenses, and increase the output temperature of a heat transfer medium from a light receiver associated with the concentrating lenses, further improving the efficiency of energy collection. On the other hand, providing the cylindrical lenslets 502a can reduce costs, as the cylindrical lenslets 502a can be cheaper to produce.

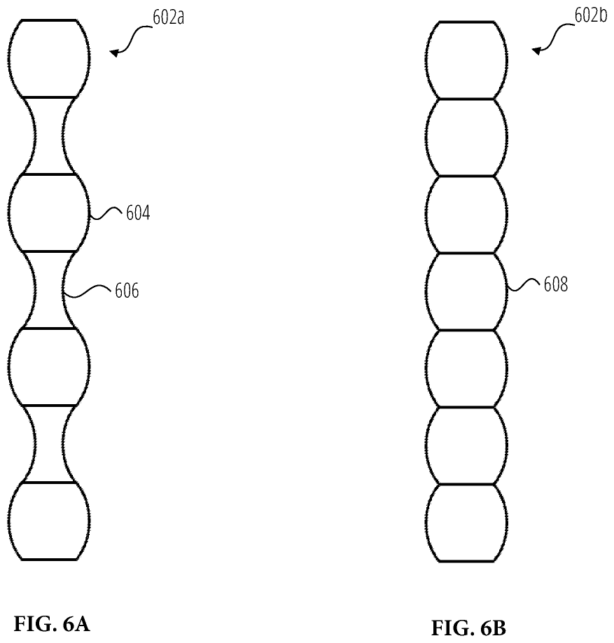

FIGS. 6A and 6B illustrate perspective views of concentrator lenses including a plurality of biconic lenslets. In FIG. 6A, a concentrating lens 602a includes a plurality of biconic lenslets, which includes convex lenslets 604 and concave lenslets 606 adjacent the convex lenslets 604. As illustrated in FIG. 6A, each convex lenslet 604 can be adjacent two concave lenslets 606, and each concave lenslet 606 can be adjacent two convex lenslets 604. Each of the convex lenslets 604 and adjacent concave lenslets 606 can focus incident light towards a focal area. In some examples, a convex lenslet 604 can focus incident light towards a first focal point, and an adjacent concave lenslet 606 can focus incident light towards the first focal point and an adjacent second focal point. Including the convex lenslets 604 and the concave lenslets 606 can focus a larger area of incident light in a smaller focal area on a light receiver, or can focus a larger area of incident light on a larger focal area on a light receiver relative to a concentrating lens that includes convex lenslets adjacent to one another or the like.

FIG. 6B illustrates the convex lenslets 604 as having convex side surfaces and the concave lenslets 606 as having concave side surfaces. In some examples, the convex lenslets 604 and the concave lenslets 606 can have planar side surfaces. The convex lenslets 604 can have convex front surfaces and/or back surfaces. The concave lenslets 606 can have concave front surfaces and/or back surfaces. Surfaces of the convex lenslets 604 can be concave and surfaces of the concave lenslets 606 can be convex. The convex lenslets 604 can focus incident light on a single focal point, while the concave lenslets 606 can focus incident light on two split focal points. Focal points of the concave lenslets 606 can overlap focal points of the convex lenslets 604.

In FIG. 6B, a concentrating lens 602b includes a plurality of biconic lenslets, which includes convex lenslets 608. Each of the convex lenslets 608 can focus incident light towards a focal point. Including the convex lenslets 608 can focus incident light towards a focal point on a light receiver, and can focus a relatively smaller area of incident light on a relatively smaller focal point, as compared to the concentrating lens 602a of FIG. 6A that includes the convex lenslets 604 and concave lenslets 606.

The convex lenslets 604 and the concave lenslets 606 of the concentrating lens 602a and the convex lenslets 608 of the concentrating lens 602b have been illustrated as being separate lenslets. However, in some examples, the convex lenslets 604 and the concave lenslets 606 of the concentrating lens 602a and the convex lenslets 608 of the concentrating lens 602b can be formed of single, continuous materials throughout the length of the concentrating lenses. In some examples, the concentrating lens 602a and the concentrating lens 602b can be manufactured through the extrusion, injection molding, machining, polishing, combinations thereof, or the like. The concentrating lens 602a and the concentrating lens 602b can be formed of suitable materials, such as polymers, acrylics, glass, combinations thereof, or the like. In some embodiments, the concentrating lens 602a and the concentrating lens 602b can be formed of polymers that can be reinforced with a webbing structure or the like. In some examples, the concentrating lens 602a and the concentrating lens 602b can be hollow, and can include a heat transfer medium disposed therein. This can further increase the efficiency of energy collection of the concentrating lens 602a and the concentrating lens 602b.

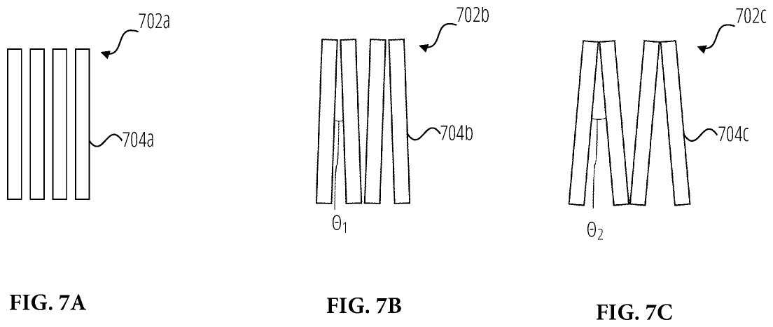

FIGS. 7A through 7C illustrate various configurations of concentrating lenses that may be provided relative to a concentrator apparatus. In FIG. 7A, each of a plurality of concentrating lenses 704a is provided in parallel in a concentrator apparatus 702a. In FIG. 7B, each of a plurality of concentrating lenses 704b is provided at an angle θ₁ relative to adjacent concentrating lenses 704b in a concentrator apparatus 702b. In FIG. 7C, each of a plurality of concentrating lenses 704c is provided at an angle θ₂ relative to adjacent concentrating lenses 704c in a concentrator apparatus 702c. In some examples, the angle θ₁ can be above 5° and the angle θ₂ can be about 10°. The angles θ₁ and θ₂ can be in a range from about 0° to about 5°, from about 0° to about 10°, from about 5° to about 10°, from about 0° to about 20°, from about 0° to about 30°, or the like. The arrangements of FIGS. 7B and 7C may be referred to as herringbone arrangements, and may alter the peak hours of solar efficiency for the concentrator apparatuses 702b and 702c. For example, providing small angles between adjacent concentrating lenses, as in the concentrator apparatuses 702b and 702c, can shift peak hours of solar efficiency earlier and later in a day. Various herringbone patterns or the like can be provided in order to alter the times of the day with peak solar energy generation, depending on the application of the concentrator apparatuses 702a, 702b, and 702c. In some examples, the concentrating lenses 704a, 704b, and 704c may be arranged in a spiral and/or star pattern around a light receiver. The arrangement of the concentrating lenses 704a, 704b, and 704c may be configured to improve the efficiency of energy collection, increase optimal solar angles, reduce manufacturing costs, make the concentrator apparatuses 702a, 702b, and 702c easier to clean or maintain clear, and/or improve durability.

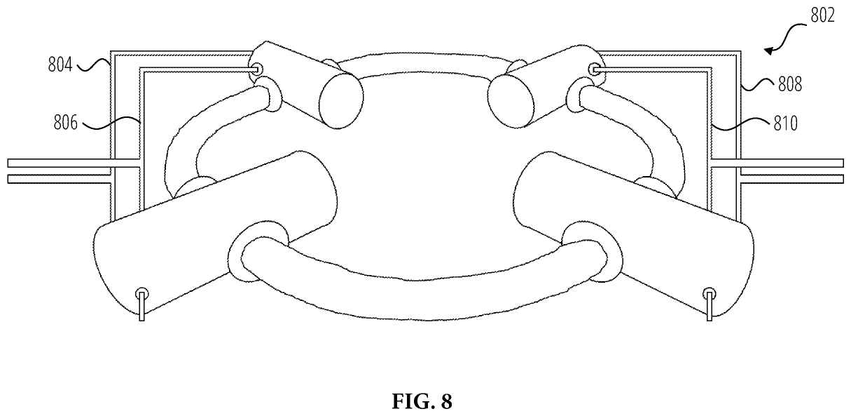

FIG. 8 illustrates heat transfer engine 802 that can be paired with or otherwise coupled to a solar optical collection system including a concentrator apparatus, as described above. The heat transfer engine 802 can include a hot transfer medium inlet 804 coupled to an output of the concentrator apparatus. In some examples, the heat transfer engine 802 can be a Sterling engine or the like. The heat transfer engine 802 can be operated by a cyclic compression and expansion of air or another gas at different temperatures, and can function as a central cooling unit. In some examples, the heat transfer engine 802 can transform thermal energy into an acoustic wave or other mechanical energy in order to produce cooling. The heat transfer engine 802 can take thermal energy from the concentrator apparatus as an input through the hot transfer medium inlet 804, and produce a cold output through a cold transfer medium outlet 808, producing cold air, cold water, or the like. The cold transfer medium outlet 808 can reach temperatures of about −25° C. The heat transfer engine 802 can include the hot transfer medium inlet 804, a hot transfer medium outlet 806, the cold transfer medium outlet 808, and a cold transfer medium inlet 810. The hot transfer medium inlet 804 can be supplied by the concentrator apparatus through an output of the concentrator apparatus. The hot transfer medium outlet 806 can be connected to an inlet of the concentrator apparatus. The cold transfer medium outlet 808 and the cold transfer medium inlet 810 can be connected to an inlet and an outlet, respectively, of a system to be cooled. Coupling the concentrator apparatus with the heat transfer engine 802 allows for solar energy to be used to provide cooling.

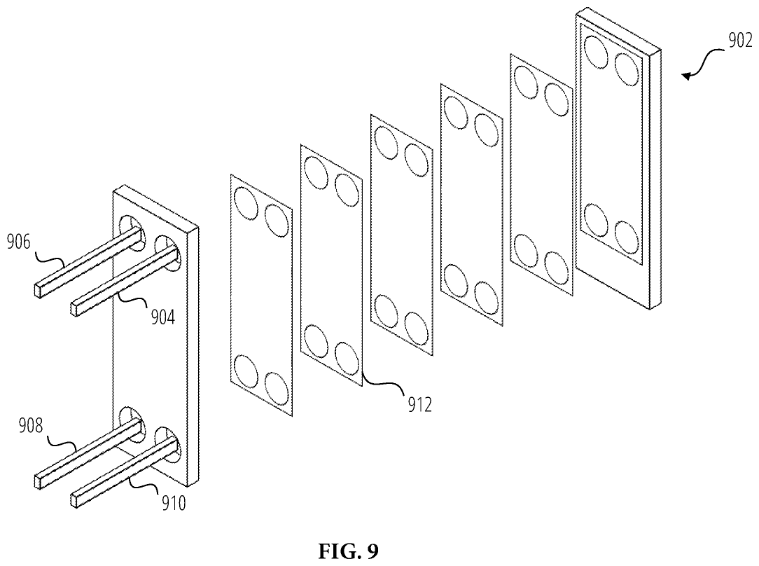

FIG. 9 illustrates heat exchanger 902 that can be paired with or otherwise coupled to a solar optical collection system including a concentrator apparatus, as described above. The heat exchanger 902 can transfer heat from a hot heat transfer medium, such as a heat transfer medium supplied by the concentrator apparatus, to a cold heat transfer medium. The heat exchanger 902 can include any suitable type of heat exchanger (e.g., double-pipe, shell-and-tube, plate, condenser, boiler, or the like), and any suitable flow arrangement (e.g., parallel-flow, counter-flow, cross-flow, or the like). The heat exchanger 902 can include a hot transfer medium inlet 904 coupled to an output of the concentrator apparatus and a hot transfer medium outlet 910 coupled to an input of the concentrator apparatus. The hot heat transfer medium flows through the heat exchanger 902 from the hot transfer medium inlet 904 to the hot transfer medium outlet 910. The heat exchanger 902 further includes a cold transfer medium inlet 908 and a cold transfer medium outlet 906. The cold heat transfer medium flows through the heat exchanger 902 from the cold transfer medium inlet 908 to the cold transfer medium outlet 906 and is heated by the hot heat transfer medium. FIG. 9 illustrates a counter-flow arrangement; however, any suitable arrangement is possible. Although the heat exchanger 902 has been discussed as being used to heat a cold heat transfer fluid, the heat exchanger 902 can be used for heating or cooling. The heat exchanger 902 can be used for space heating, refrigeration, air conditioning, in power stations, chemical plants, petrochemical plants, petroleum refineries, natural-gas processing, sewage treatment, or any other suitable applications. Coupling the concentrator apparatus with the heat exchanger 902 allows for solar energy to be used to provide heat exchange in a variety of applications. The heat exchanger 902 is illustrated as including 7 heat exchange stages 912; however, any number of the heat exchange stages 912 can be provided.

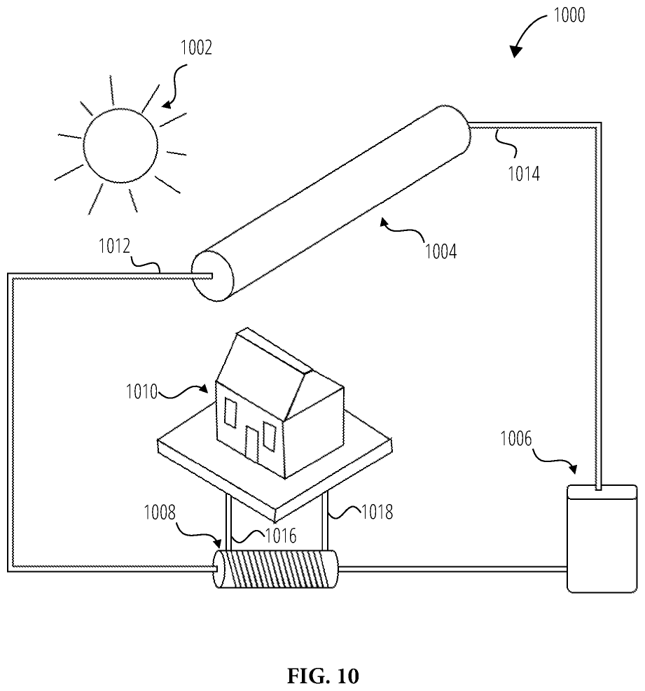

FIG. 10 illustrates a solar optical collection system 1100 that can be used in a home. However, the system 1100 of FIG. 10 is also applicable to industrial applications and the like. In FIG. 10, the sun 1002 supplies solar radiation, which is concentrated and collected by a concentrator apparatus 1004. The concentrator apparatus 1004 can include any of the previously-described concentrator apparatuses. A heat transfer medium is supplied to the concentrator apparatus 1004 through a transfer medium inlet 1012, is heated by the concentrator apparatus 1004, and exits the concentrator apparatus 1004 through a transfer medium outlet 1014. The heat transfer medium can include water, hydrocarbon oils, molten salts, glycols (e.g., ethylene glycol, propylene glycol, or the like), refrigerants, phase change fluids, ionic liquids, zeolite materials, silicones, combinations thereof, or the like.

The heat transfer medium is supplied from the transfer medium outlet 1014 of the concentrator apparatus 1004 to an energy storage reservoir 1006. The energy storage reservoir 1006 may include an insulated tank, zeolite thermal storage, molecular solar thermal energy storage (MOST), molten salt storage, a fuel generator, or any other heat storage means.

The heat transfer medium is supplied from the energy storage reservoir 1006 to a heat exchanger 1008. The heat transfer medium can be used to heat an additional heat transfer medium in the heat exchanger 1008. For example, the heat transfer medium can heat the additional heat transfer medium in the heat exchanger 1008 to supply heat to a house 1010. The heat exchanger 1008 can include a transfer medium outlet 1018 and a transfer medium inlet 1016. In some examples, the transfer medium outlet 1018 can supply hot water to the house 1010, and cold water can be supplied to the heat exchanger 1008 through the transfer medium inlet 1012.

Cooled heat transfer medium is supplied from the heat exchanger 1008 back to the concentrator apparatus 1004 through the transfer medium inlet 1012. Although the system 1000 has been discussed in the context of providing heat through hot water to the house 1010, the system 1000 can be used to provide heat, electricity, water, fuel, or the like to the house 1010 or in other applications, according to any of the examples discussed in this application.

Individual homes, buildings, or communities can use the concentrator apparatus 1004 to heat water. Such heated water can be used to run showers, dishwashers, washing machines, or other home-based or industry-based applications. In some examples, the water can be converted into steam which can be used to power a turbine for electricity generation. In some examples, the heated water can be used in a heat exchanger that can be used to heat or cool a building, generate electricity, heat a pool, heat sidewalks, heat driveways or roads, regulate a climate within a building, heat other objects, regulate the temperature of other objects, or combinations thereof.

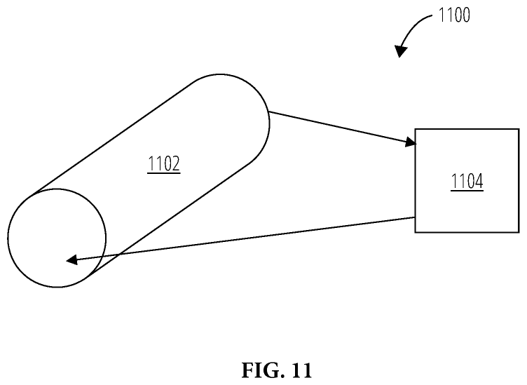

FIG. 11 illustrates a system 1100 that includes a concentrator apparatus 1102 and an energy conversion apparatus 1104. The concentrator apparatus 1102 can include any of the previously-described concentrator apparatuses, and can include a plurality of concentrating lenses and a light receiver, as described previously. A heat transfer medium can be fed to the concentrator apparatus 1102 through an inlet of the concentrator apparatus 1102, heated by the concentrator apparatus 1102, and supplied from an outlet of the concentrator apparatus 1102 to an inlet of the energy conversion apparatus 1104. Energy can be extracted from the heat transfer medium by the energy conversion apparatus 1104, which can cool the heat transfer medium, and the heat transfer medium can be fed from an outlet of the energy conversion apparatus 1104 back to the inlet of the concentrator apparatus 1102.

In some examples, the energy conversion apparatus 1104 can be an atmospheric water generator. The concentrator apparatus 1102 of the system 1100 can be used to supply heat through the heat transfer medium to the atmospheric water generator, which produces potable water by extracting water vapor from ambient air. The system 1100 including the concentrator apparatus 1102 and the atmospheric water generator can be used in a range of applications, such as home-based units, commercial-scale units, or the like. In some examples, the atmospheric water generator can use a combination of desiccants and thermal energy provided by the concentrator apparatus 1102 through the heat transfer medium to extract water from the atmosphere. The concentrator apparatus 1102, as described above, can be transparent and lightweight, which allows the system 1100 including the concentrator apparatus 1102 to be installed anywhere. Moreover, the concentrator apparatus 1102 is stackable, and can be fitted in any desired space.

In some examples, the energy conversion apparatus 1104 can be a fuel generator. The concentrator apparatus 1102 of the system 1100 can be used to supply heat through the heat transfer medium to the fuel generator, which produces fuels, such as gasoline, diesel, jet fuel, or the like from carbon dioxide and water. This process may be referred to as artificial photosynthesis. The fuel generator can include an enzyme bed reactor, which fixes carbon dioxide from the air. The carbon dioxide and water, along with heat generated from the concentrator apparatus 1102 and supplied through the heat transfer medium, are then fed to a thermochemical reactor, which produces a mixture of hydrogen and carbon monoxide, referred to as syngas or synthesis gas. The carbon dioxide and water can be thermo-chemically split using a two-step redox reaction with heat supplied by the heat transfer medium from the concentrator apparatus 1102 in order to yield the syngas. The syngas is processed by gas-to-liquids technologies in order to convert the syngas to fuels, such as gasoline, diesel, jet fuel, or the like. As such, the concentrator apparatus 1102 can be used in combination with fuel generators in order to produce fuel.

In some examples, the energy conversion apparatus 1104 can be an ammonia generator. The concentrator apparatus 1102 of the system 1100 can be used to supply heat through the heat transfer medium to the ammonia generator, which produces ammonia. The ammonia generator can use a process, such as the Haber-Bosch process to produce ammonia. The ammonia can be used as a fuel, for fertilizer, or the like. For example, heat of the heat transfer medium of the concentrator apparatus 1102 can be used to power systems of the energy conversion apparatus 1104 that capture water and perform electrolysis on that water in order to produce hydrogen. The hydrogen can be combined with nitrogen from the air to produce ammonia in the ammonia generator. Both the electrolysis process and the ammonia production process can use heat and energy supplied through the heat transfer medium of the concentrator apparatus 1102 as energy sources for chemical processes. As such, the concentrator apparatus 1102 and the system 1100 can be used in to generate ammonia, which can be used as fuel storage, fertilizers, and the like.

Because of the size and flexibility of the concentrator apparatus 1102, the concentrator apparatus 1102 can be used in a variety of applications. Additional potential applications include on the sides of wind turbines, wrapped around trees, on the tops of refrigeration trucks or shipping containers, and military applications, such as on-site power generation. The concentrator apparatus 1102 can be paired with an energy conversion apparatus 1104 that is a thermoelectric cooling system. For example, the concentrator apparatus 1102 can be used to power a thermoelectric cooling system, such as a system that uses the Peltier effect. The concentrator apparatus 1102 is lightweight, can be stacked, can be formed of flexible materials, and the like, and is therefore useful in a variety of applications.

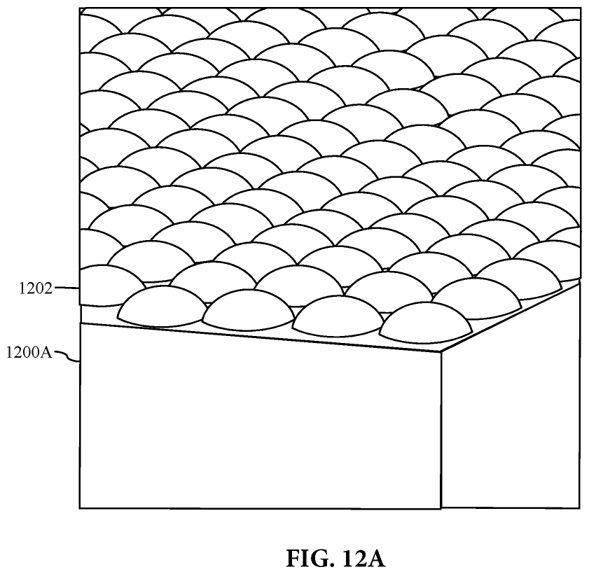

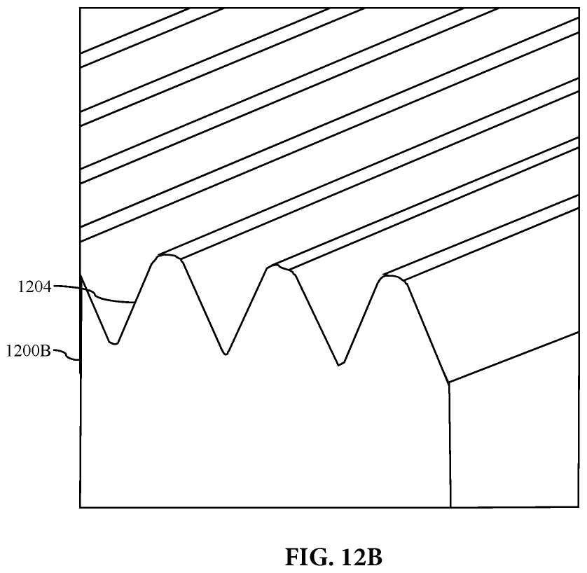

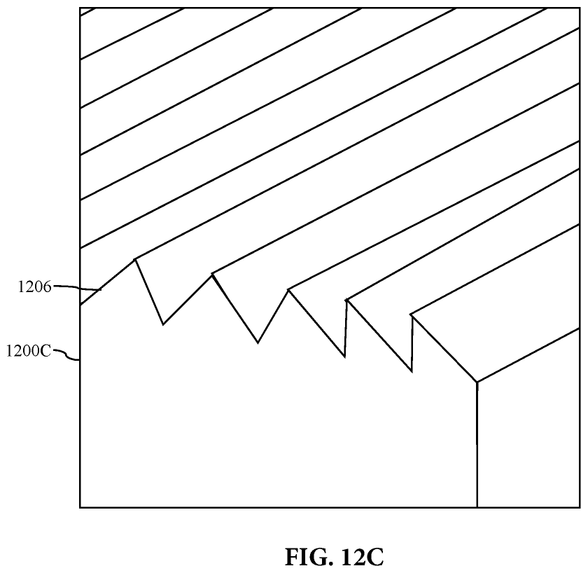

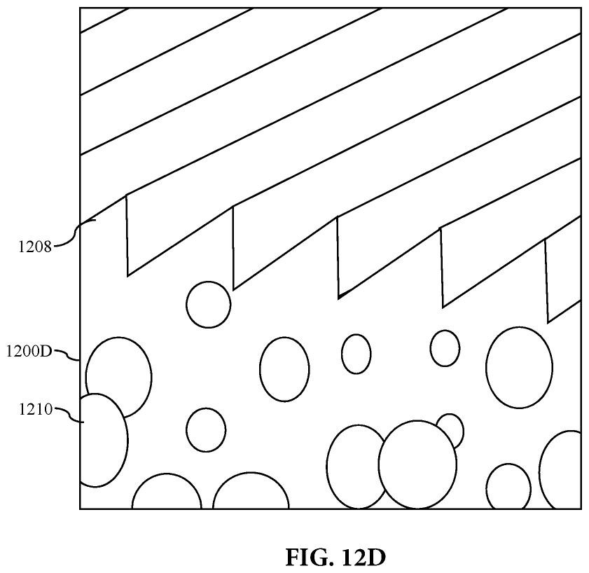

FIGS. 12A through 12D illustrate various configurations of optical materials that can be provided for concentrating lenses that can be included in concentrator apparatuses, as described herein. In FIG. 12A, an optical material 1200A includes structures 1202 on a surface thereof. The structures 1202 can be provided such that the optical material 1200A has a textured surface. The structures 1202 can be nano-spheres, microspheres, other spherical or partially spherical shapes, or the like. In some examples, the structures 1202 can be pyramidal, another polyhedron, or the like. The optical material 1200A and/or the structures 1202 can be formed of suitable materials, such as polymers, acrylics, glass, combinations thereof, or the like. The structures 1202 can be formed from materials the same as or different from the bulk of the optical material 1200A. In some examples, the structures 1202 can be nanostructures, which can be formed by nano-shaping techniques. In some examples, the structures 1202 can include an oleophobic coating that is applied to the optical material 1200A. The optical material 1200A and/or the structures 1202 can be formed by extrusion, 3D printing, blasting, machining, combinations thereof, or the like.

In FIG. 12B, an optical material 1200B includes structures 1204 on a surface thereof. The structures 1204 can be provided such that the optical material 1200B has a textured surface. The structures 1204 can be prisms, lenticulars, partial-lenticulars, or any other suitable shapes. The optical material 1200B and/or the structures 1204 can be formed of suitable materials, such as polymers, acrylics, glass, combinations thereof, or the like. The structures 1204 can be formed from materials the same as or different from the bulk of the optical material 1200B. In some examples, the structures 1204 can be nanostructures, which can be formed by nano-shaping techniques. In some examples, the structures 1204 can include an oleophobic coating that is applied to the optical material 1200B. The optical material 1200B and/or the structures 1204 can be formed by extrusion, 3D printing, blasting, machining, combinations thereof, or the like.

In FIG. 12C, an optical material 1200C includes structures 1206 on a surface thereof. The structures 1206 can be provided such that the optical material 1200C has a textured surface. The structures 1206 can be Fresnel features, linear Fresnel features, or any other suitable shapes. The optical material 1200C and/or the structures 1206 can be formed of suitable materials, such as polymers, acrylics, glass, combinations thereof, or the like. The structures 1206 can be formed from materials the same as or different from the bulk of the optical material 1200C. In some examples, the structures 1206 can be nanostructures, which can be formed by nano-shaping techniques. In some examples, the structures 1206 can include an oleophobic coating that is applied to the optical material 1200C. The optical material 1200C and/or the structures 1206 can be formed by extrusion, 3D printing, blasting, machining, combinations thereof, or the like.

In FIG. 12D, an optical material 1200D includes structures 1208 on a surface thereof. The structures 1208 can be provided such that the optical material 1200D has a textured surface. The structures 1208 can be prisms, lenticulars, partial-lenticulars, Fresnel features, linear Fresnel features, or any other suitable shapes. The optical material 1200D and/or the structures 1208 can be formed of suitable materials, such as polymers, acrylics, glass, combinations thereof, or the like. The structures 1208 can be formed from materials the same as or different from the bulk of the optical material 1200D. In some examples, the structures 1208 can be nanostructures, which can be formed by nano-shaping techniques. In some examples, the structures 1208 can include an oleophobic coating that is applied to the optical material 1200D. The optical material 1200D and/or the structures 1208 can be formed by extrusion, 3D printing, blasting, machining, combinations thereof, or the like.

The structures 1202, 1204, 1206, and 1208 can be provided to prevent water, dust, dirt, debris, and other contaminants from building up on surfaces of the optical materials 1200A-D, which can reduce cleaning costs for concentrator apparatuses, and improve efficiency of the concentrator apparatuses. In examples in which the structures 1202, 1204, 1206, 1208 are formed by nano-shaping, or have nano-sized critical dimensions, the optical materials 1200A-D can have extremely smooth exterior surfaces, which further prevents water, dust, dirt, debris, and other contaminants from building up on surfaces of the optical materials 1200A-D. As such, the optical materials 1200A-D can be referred to as self-cleaning. The structures 1202, 1204, 1206, 1208 can be metastructures, and can concentrate light in the optical materials 1200A-D, which is further concentrated by the concentrating lenses including the optical materials 1200A-D. This can further concentrate light and improve the efficiency of concentrator apparatuses.

Further in FIG. 12D, the optical material 1200D includes additives 1210 incorporated therein. The additives 1210 can include materials that shift wavelengths of incident light. For example, the additives 1210 can absorb shorter wavelengths and emit longer wavelengths to shift incident light to longer wavelengths. Shifting the light to longer wavelengths before the light is incident on a heat transfer medium or other light receiver can increase heat transfer from the light to the heat transfer medium or light receiver, increasing the efficiency of concentrator apparatuses. In some examples, the additives 1210 can include phosphors, quantum dots (QDs), luminophores, combinations thereof, or the like. In an example, the additives 1210 can include an Eu3+ luminophore with a photosensitizer (e.g., hexafluoroacetylacetonato or the like) and a stabilizer (e.g., triphenylphosphine oxide (TPPO), and can have a formula Eu(hfa)₃(TPPO)₂. Any of the optical materials 1200A-D can include the additives 1210.

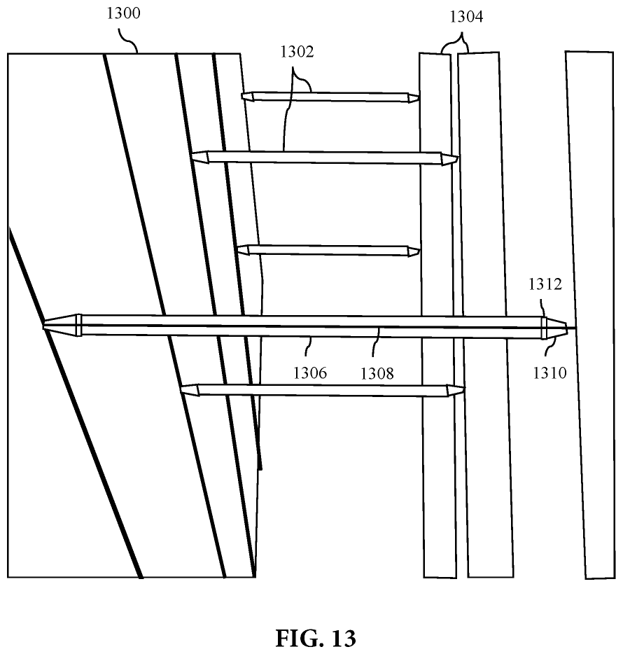

FIG. 13 illustrates incorporation of concentrator apparatuses into horizontal beams 1302 that can be used as structural supports between a building 1300 and columns 1304. The beams 1302 can include an outer glass tube 1306 and an inner cable 1308. The outer glass tube 1306 can include various concentrator lenses, as described above, and a heat transfer medium or other light receiver can surround the inner cable 1308. The outer glass tube 1306 can be a light concentrator that surrounds the heat transfer medium or light receiver. The outer glass tube 1306 of the beams 1302 can be formed from structural glass. In some examples, the structural glass can include a laminated glass structure. In some examples, the structural glass can include adhesive layers (e.g., polyvinyl butyral (PVB) foil layers, ethylene-vinyl acetate (PVA) foil layers, or the like) between layers of glass. The beams 1302 can include tube end components 1310 with ball-and-socket joints for force transfer between the beams 1302, the building 1300, and the columns 1304. Connectors 1312, which may be formed from basis sheet steel or the like, can be provided between the outer glass tube 1306 and the tube end components 1310 to connect the outer glass tube 1306 and the tube end components 1310. Concentrator apparatuses can replace existing structural components of buildings and other structures to provide solar energy without an increased footprint. Moreover, concentrator apparatuses incorporated into structural glass can improve aesthetics of a building or other structure.

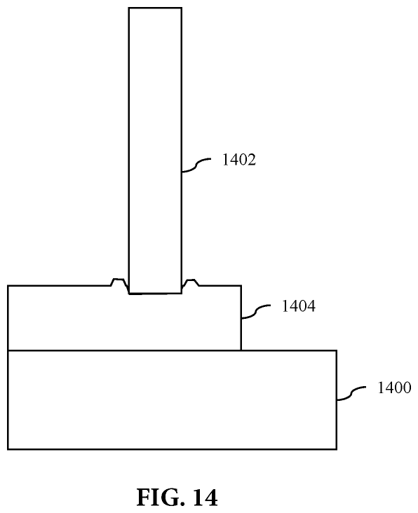

FIG. 14 illustrates incorporation of a concentrator apparatus into a vertical beam 1402 that can be used as vertical structural support on a support 1400. An intermediate layer 1404 can be provided between the beam 1402 and the support 1400. The beam 1402 can include an outer glass tube, which can include materials similar to or the same as the outer glass tube 1306, discussed above with respect to FIG. 13. The outer glass tube can include various concentrator lenses, as described above, and can encircle or otherwise surround a heat transfer medium or other light receiver. In some examples, the support 1400 can include a structural material, such as steel or the like. Concentrator apparatuses can replace existing structural components of buildings and other structures to provide solar energy without an increased footprint. Moreover, concentrator apparatuses incorporated into structural glass can improve aesthetics of a building or other structure.

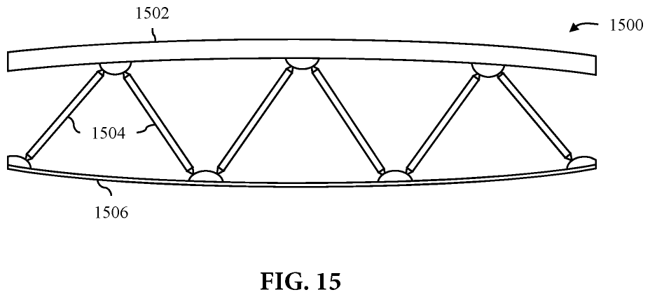

FIG. 15 illustrates incorporation of concentrator apparatuses into diagonal beams 1504 that can be used as structural supports between an upper beam 1502 and a lower beam 1506 in a bridge 1500. The beams 1504 can be the same as or similar to the beams 1302, discussed above with respect to FIG. 13. The beams 1502, 1506 can include structural materials, such as steel or the like. Concentrator apparatuses can replace existing structural components of bridges and other structures to provide solar energy without an increased footprint. Moreover, concentrator apparatuses incorporated into structural glass can improve aesthetics of a bridge or other structure.

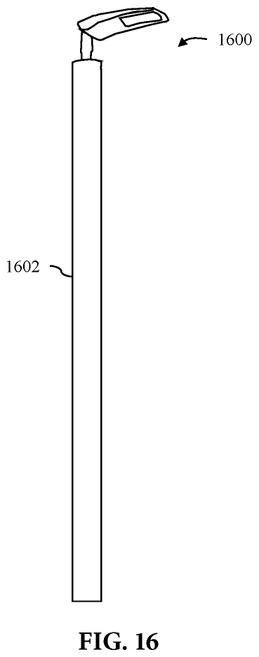

FIG. 16 illustrates incorporation of a concentrator apparatus into a post 1602 that can be used for a streetlamp 1600. The post 1602can be the same as or similar to the beams 1302, discussed above with respect to FIG. 13 or the beam 1402, discussed above with respect to FIG. 14. Concentrator apparatuses can replace existing structural components of streetlamps and other structures to provide solar energy without an increased footprint. Moreover, concentrator apparatuses incorporated into structural glass can improve aesthetics of a streetlamp or other structure.

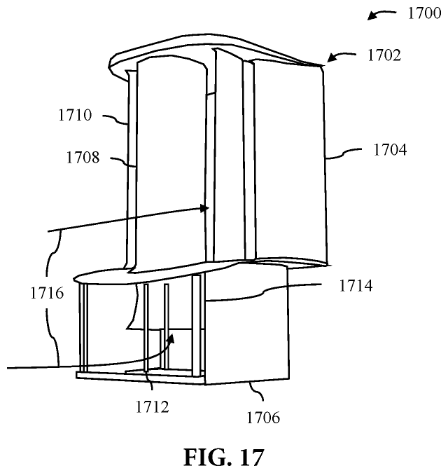

FIG. 17 illustrates a system 1700 that includes any of the concentrator apparatuses discussed above. In some examples, the system 1700 includes concentrator apparatuses incorporated with a wind turbine 1702. The concentrator apparatuses can be substantially analogous to the concentrator apparatus 102, 200, 302a, 302b described herein. For example, the concentrator apparatuses can utilize an arrangement of concentrating lenses to facilitate the omnidirectional concentration of light toward a light receiver. A heat transfer medium can be introduced to the concentrator apparatuses at a heat transfer medium inlet, and can receive thermal energy via the arrangement of concentrating lenses. The transfer medium can exit the concentrator apparatuses having an increased temperature at a heat transfer medium outlet.

The wind turbine 1702 can be a wind energy capture system. The wind turbine 1702 includes an upper air intake 1704 and a lower air intake 1706. The upper air intake 1704 includes a center tube 1708 and air foils 1710. In some examples, the center tube 1708 and/or the air foils 1710 can be concentrator apparatuses. The lower air intake 1706 includes supports 1712 and a propeller 1714. In some examples, the supports 1712 can be concentrator apparatuses. Wind 1716 can pass through the upper air intake 1704 and into the lower air intake 1706. As the wind 1716 passes the center tube 1708 and the air foils 1710, the wind 1716 can create a low pressure, which pulls wind 1716 through the lower air intake 1706 past the propeller 1714. The wind 1716 rotating the propeller 1714 generates energy. Wind turbines 1702 can be placed on buildings and other structures in positions that use the size and shape of the building to maximize wind flow to the wind turbines 1702, thereby increasing energy generation.

The concentrator apparatuses can be incorporated into the center tube 1708, the air foils 1710, the supports 1712, and/or any other components of the wind turbine 1702. In some examples, the concentrator apparatuses can be formed of structural glass or the like, as discussed above with respect to the beams 1302. The concentrator apparatuses can improve the aesthetics of the wind turbine 1702, while also improving energy generation by the wind turbine 1702. The concentrator apparatuses can transfer solar radiation into heat, which can raise a heat profile of the wind turbine 1702. This additional heat can increase air differentials within the wind turbine 1702, increasing wind speed through the wind turbine 1702, which increases energy generation by the wind turbine 1702. Specifically, temperature gradients can cause differences in air pressure between locations, which can increase wind speed between the locations. The concentrator apparatuses can transfer radiation energy to a heat transfer medium, which can be transferred within the wind turbine 1702 to a location to maximize a pressure differential and wind speed within the wind turbine 1702. Incorporating the concentrator apparatuses into wind turbines 1702 can improve the efficiency of the wind turbines 1702, and can convert solar radiation energy collected by the concentrator apparatuses into usable electrical energy, without requiring additional generators, such as Sterling engines or the like. In some examples, water generation systems, such as atmospheric water generators that use thermal energy to extract water vapor from ambient air, can further be incorporated into the system 1700 to further improve the efficiency of the system 1700.

Various disclosures have been described herein with reference to certain specific embodiments and examples. However, those skilled in the art recognize that many variations are possible without departing from the scope and spirit of the disclosures discussed herein, in that those disclosures set forth in the claims below are intended to cover all variations and modifications of the disclosures discussed without departing from the spirit of the disclosure. The terms “including” and “having,” as used in the specification and claims, shall have the same meaning as the term “comprising.”

The foregoing description, for purposes of explanation, used specific nomenclature to provide a thorough understanding of the described embodiments. However, it can be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It can be apparent to one of ordinary skill in the art that many modifications and variations are possible in view of the above teachings.

What is claimed is:

1. A concentrator apparatus comprising:
a light receiver; and
a light concentrator, the light concentrator including:
a first concentrating lens with a first focal point on the light receiver; and
a second concentrating lens adjacent to the first concentrating lens in a direction parallel to a longitudinal axis of the light receiver, the second concentrating lens having a second focal point on the light receiver, wherein the second focal point is spaced apart from the first focal point.

2. The concentrator apparatus of claim 1, wherein the second concentrating lens is directly adjacent the first concentrating lens, and wherein the first concentrating lens and the second concentrating lens are convex lenses.

3. The concentrator apparatus of claim 1, further comprising a third concentrating lens between the first concentrating lens and the second concentrating lens, wherein the first concentrating lens and the second concentrating lens are convex lenses, wherein the third concentrating lens is a concave lens.

4. The concentrator apparatus of claim 3, wherein the third concentrating lens has a third focal point at least partially overlapping the first focal point and the second focal point.

5. The concentrator apparatus of claim 1, wherein the light receiver comprises a molecular solar thermal energy storage (MOST).

6. The concentrator apparatus of claim 1, wherein the light receiver and the light concentrator comprise flexible materials.

7. The concentrator apparatus of claim 1, further comprising a transparent material encircling the light concentrator and the light receiver, wherein the transparent material defines at least a partial vacuum between the light concentrator and the light receiver.

8. A system comprising:
a light receiver configured to conduct a heat transfer medium; and
a light concentrator comprising a cylindrical lens, the cylindrical lens being configured to direct light passing through the light concentrator to a first focal point on the light receiver and a second focal point on the light receiver and spaced apart from the first focal point.

9. The system of claim 8, wherein the first focal point is axially spaced apart from the second focal point.

10. The system of claim 8, wherein the cylindrical lens comprises a plurality of biconic lenslets.

11. The system of claim 8, further comprising a sterling engine coupled to an outlet of the light receiver.

12. The system of claim 8, further comprising a water generator coupled to an outlet of the light receiver, wherein the water generator is configured to generate water using heat from the heat transfer medium.

13. The system of claim 8, further comprising an ammonia generator coupled to an outlet of the light receiver, wherein the ammonia generator is configured to generate ammonia using heat from the heat transfer medium to capture water and perform electrolysis on the water.

14. A light-concentrating lens comprising:
a light-receiving surface; and
a light-exiting surface opposite the light-receiving surface, wherein:
the light-receiving surface comprises a plurality of nano-structures configured to resist build-up of contaminants; and
the light-concentrating lens comprises an additive configured to shift a wavelength of light passing from the light-receiving surface to the light-exiting surface.

15. The light-concentrating lens of claim 14, wherein the additive comprises at least one of a phosphor, a quantum dot (QD), or a luminophore.

16. The light-concentrating lens of claim 14, wherein the additive further comprises a photo sensitizer and a stabilizer.

17. The light-concentrating lens of claim 15, wherein:
the luminophore comprises Eu3+;
the photo sensitizer comprises hexafluoroacetylacetonato; and
the stabilizer comprises triphenylphosphine oxide.

18. The light-concentrating lens of claim 14, wherein the plurality of nano-structures are spherical.

19. The light-concentrating lens of claim 14, wherein the nano-structures comprise at least one of prisms, lenticulars, or linear Fresnel features.

20. The light-concentrating lens of claim 14, wherein the additive is configured to shift the wavelength of light passing from the light-receiving surface to the light-exiting surface from a shorter wavelength to a longer wavelength.
